(19) United States
(12) Patent Application Publication
(10) Pub. No.: US 2020/0310867 A1
(43) Pub. Date: Oct. 1, 2020

(54) APPLICATION MIGRATION MANAGEMENT

(71) Applicant: International Business Machines Corporation, Armonk, NY (US)

(72) Inventors: GUANG CHENG LI, BEIJING (CN); QI MING TENG, Beijing (CN); YONG ZHENG, Beijing (CN); LIN FENG SHEN, Beijing (CN)

(21) Appl. No.: 16/371,712

(22) Filed: Apr. 1, 2019

(51) Int. Cl. G06F 9/48; G06F 16/21

(52) U.S. Cl. CPC G06F 9/4856; G06F 2209/482; G06F 16/214

(57) ABSTRACT

Embodiments of the present invention relate to methods, systems, and computer program products for application migration management. In a method, an application that is to be migrated may be determined by one or more processors in response to detecting an event in a node in a plurality of nodes, the application and application data of the application being located in the node. A group of candidate nodes to which the application is to be migrated may be determined from the plurality of nodes by one or more processors. The application data of the application may be relocated by one or more processors from the node to the group of candidate nodes. With these embodiments, the application data may be copied to the candidate nodes in advance, and the migrated application may be directly run, such that a time cost of the migration may be greatly reduced.

### BACKGROUND

The present invention generally relates to application migration. Specifically, the present invention relates to computer-implemented methods, computer-implemented systems and computer program products for managing application migration among a plurality of nodes.

With developments of distributed systems, applications and their application data may be dynamically located among a plurality of nodes in a distributed system. Meanwhile, the distributed system may leverage the distribution of the applications among the plurality of nodes so as to achieve better performances or other purposes.

### SUMMARY

In one aspect, a computer-implemented method is disclosed. According to the method, an application that is to be migrated may be determined by one or more processors in response to detecting an event in a node in a plurality of nodes, the application and application data of the application being located in the node. A group of candidate nodes to which the application is to be migrated may be determined from the plurality of nodes by one or more processors. The application data of the application may be relocated by one or more processors from the node to the group of candidate nodes.

In another aspect, a computer-implemented system is disclosed. The computing system comprises a computer processor coupled to a computer-readable memory unit, where the memory unit comprises instructions that when executed by the computer processor implements the above method.

In another aspect, a computer program product is disclosed. The computer program product comprises a computer readable storage medium having program instructions embodied therewith. The program instructions are executable by an electronic device to cause the electronic device to perform actions of the above method.

It is to be understood that the summary is not intended to identify key or essential features of embodiments of the present invention, nor is it intended to be used to limit the scope of the present embodiment. Other features of the present embodiment will become easily comprehensible through the description below.

### BRIEF DESCRIPTION OF THE DRAWINGS

Through the more detailed description of some embodiments of the present embodiment in the accompanying drawings, the above and other objects, features and advantages of the present embodiment will become more apparent, wherein the same reference generally refers to the same components in the embodiments of the present embodiment.

FIG. 1 depicts a cloud computing node according to an embodiment of the present invention;

FIG. 2 depicts a cloud computing environment according to an embodiment of the present invention;

FIG. 3 depicts abstraction model layers according to an embodiment of the present invention;

FIG. 4 depicts an example diagram for managing application migration according to an embodiment of the present invention;

FIG. 5 depicts an example flowchart of a method for managing application migration according to an embodiment of the present invention;

FIG. 6 depicts an example diagram for a group of candidate nodes according to an embodiment of the present invention;

FIG. 7 depicts an example diagram for a distributed system comprising multiple replicas of the application data according to an embodiment of the present invention;

FIG. 8 depicts an example diagram for a group of candidate nodes according to an embodiment of the present invention;

FIG. 9 depicts an example diagram for a distributed system where data distribution of replicas for application data is changed according to an embodiment of the present invention.

Throughout the drawings, same or similar reference numerals represent the same or similar elements.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

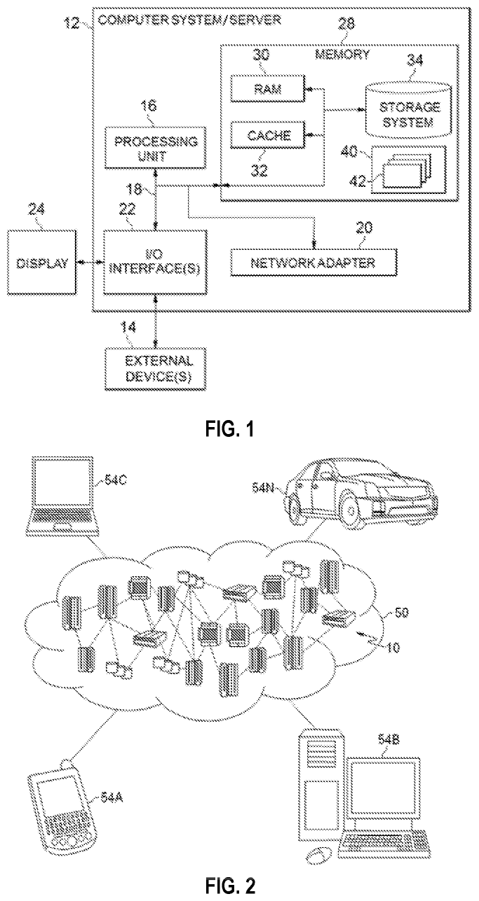

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and migration management 96.

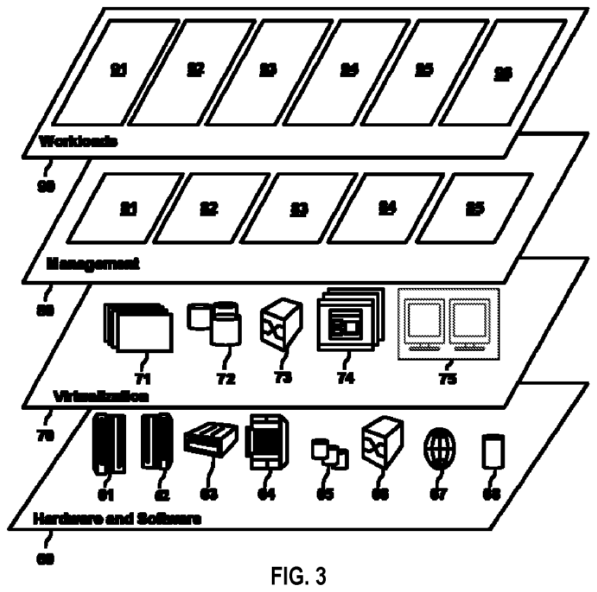

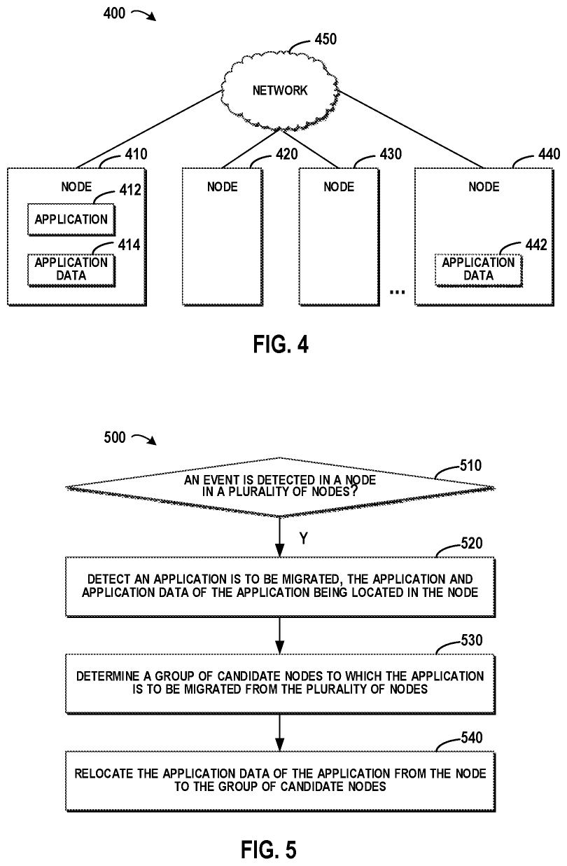

It should be noted that the processing of migration management according to embodiments of this invention could be implemented by computer system/server 12 of FIG. 1. Hereinafter, reference will be made to FIG. 4 to FIG. 9 to describe details of the migration management 96.

Nowadays, container techniques are widely adopted in distributed systems and containers frequently migrate among various nodes in the distribute system. For the sake of description, embodiments of the present invention will be described by taking a distributed system supporting containers as an environment for implementing embodiments of the present invention. Further, a container will be taken as an example of an application in describing the application migration.

In the container environment, a Container Orchestration Engine (COE) which relates to a plurality of worker nodes may be deployed for provisioning and managing containers through lifecycles of the containers. Here, although some types of containers do not have its own persistent storage, a stateful container may have its own persistent volume for storing the container's private data, configuration and other data. The persistent volume has independent lifecycle from the container and this volume may persist even if the corresponding container is killed. Sometimes, the container may be migrated from one node to another manually or automatically for the purpose of better performance or trouble shooting. At this point, the persistent volume should be moved together with the container so as to support the migrated container, and how to manage the application migration in a more effective way becomes a focus.

Reference will be made to FIG. 4 for a general description of the working environment. As shown in FIG. 4, a distributed system 400 may comprise a plurality of nodes 410, 420, 430, . . . , and 440, and these nodes are connected via a network 450. An application 412 and application data 414 of the application 412 may be located in the node 410. When the application 412 is to be migrated to another node, the application data 414 should be migrated together with the application 412.

There are various existing solutions for managing application migration, for example, there are solutions for managing the application and its application data during the real migration of the application. However, the migration has been started and these solutions are remediation strategies and cannot provide effective preparation before the application is really migrated.

In view of the above, the present invention provides an effective solution for managing application migration that may provide early preventive measures in advance. Hereinafter, reference will be made to FIG. 4 for a general description of embodiments of the present invention. As shown in FIG. 4, before the application 412 is really migrated, it is estimated whether the migration is coming or not. If it is estimated that the application 412 should be migrated, the application data 414 may be relocated to a candidate node 440 (to which the application 412 may possibly be migrated) to form application data 442. Usually, the application data 414 may be of a certain size and the time duration for transferring the application data 414 may not be ignored. Compared with copying the application data 414 during the migration or after the migration, the application data 442 may be copied to the node 440 in advance. Accordingly, if the application 412 is really migrated to the node 440, the migrated application may be directly run, and the time cost of the migration may be greatly reduced.

Reference will be made to FIG. 5 for more details about embodiments of the present invention. FIG. 5 depicts an example flowchart of a method 500 for managing migration according to an embodiment of the present invention. At block 510, it may be determined whether an event occurs in the node 410 in a plurality of nodes 410, 420, 430, . . . , and 440. Here, the application 412 and its application data 414 are located in the node 410. The event may be a signal indicating that the application 412 should be migrated to another node in the plurality of nodes 410, 420, 430, . . . , and 440.

In some embodiments of the present invention, the event in the node 410 may comprise a performance of the node 410 being below a predefined threshold. In order to ensure that the application 412 may be executed in an effective way, it is desired that the performance of the node 410 is in a high level. However, with an increase of workloads of the node 410, the performance of the node 410 may drop and may not be suitable for executing the application 412 any longer. At this point, if the performance of the node 410 is below the predetermined threshold, it may be determined that the event indicts a migration occurred in the node 410.

In some embodiments of the present invention, the event in the node 410 may comprise a failure being detected in the node 410. Usually, if a failure occurs in the node 410, the node 410 should be restarted or subjected to other maintenance measures for trouble shooting. At this point, the node 410 is not suitable for hosting the application 412 again, and thus it may be determined that the event indicts a migration occurred in the node 410.

In some embodiments of the present invention, the event in the node 410 may comprise an instruction for migrating the application 412. Sometimes, an administrator or a scheduler of the distributed system may issue an instruction for migrating the application 412. For example, if the administrator will shut down the node 410 or for other reasons, the administrator may issue this type of instruction. For another example, if the scheduler will clear all the applications on the node 410, the scheduler may also issue this type of instruction. At this point, if the instruction is received, it may be determined that the event indicting a migration occurred in the node 410.

If any of the above events occurs in the node 410, the workflow of the method 400 may proceeds to block 520. At block 520, a migration prediction of the application 412 that is located in the node 410 may be determined. The migration prediction may represent that both of the application 412 and application data 414 of the application 412 being located in the node 410 should be migrated to another node in the plurality of nodes 410, 420, 430, . . . , and 440.

At block 530, a group of candidate nodes may be determined from the plurality of nodes 410, 420, 430, . . . , and 440. Here, a candidate node in the group may represent a node to which the application 412 is to be migrated. In some embodiments of the present invention, the number of the candidate nodes in the group may be determined based on a predefined rule. In some embodiments, the number of candidate nodes may be set to a predetermined value. The greater the number is, the higher probability the group of candidate nodes may cover all potential destination nodes for the migration. For example, the number may be set to two or another value. At this point, the application data 414 may be relocated to two candidate nodes in the plurality of nodes. If the application 412 is scheduled to be migrated to a node with better performance in the plurality of nodes, then the two nodes with the top performance may be determined as the candidate nodes. At this point, whenever the application 412 is to be migrated to any of the two candidate nodes, the migrated application may directly run after the migration.

In some embodiments, the number of candidate nodes may be determined in proportion to the total number of the plurality nodes. The greater the total number is, the greater the number of the candidate nodes is. Sometimes, the plurality of node reach a great number such as a thousand, and the application 412 might possibly be migrated to many candidate nodes depending on various complicated migration rules. At this point, the number of candidate nodes may be set to a relative greater value such as 5 or another number, so as to cover more potential destination nodes for the migration.

Further, a relocating cost may be considered in determining the number of the candidate nodes. As relocating the application data 414 may occupy additional network bandwidth and processing resources in the distributed system, the number of the candidate nodes may be determined based on a balance between the relocating cost and the probability for covering the destination node.

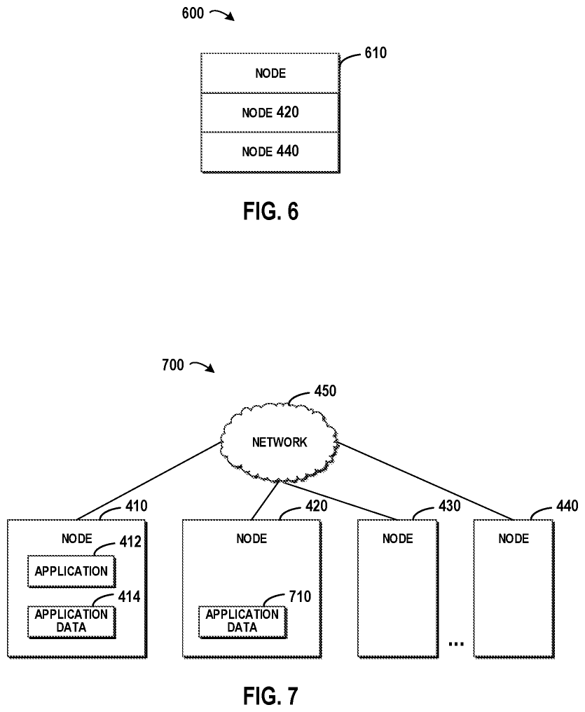

FIG. 6 depicts an example diagram 600 for a group of candidate nodes according to an embodiment of the present invention. Here, the group comprises one column 610 for indicating identifications of the candidate nodes. In the column 610, there are two candidate nodes: the node 420 and the node 440. With the group of candidate nodes, the application data 414 may be relocated to the node 420 as well as the node 440. Hereinafter, descriptions will be provided for how to determine the candidate nodes.

In some embodiments of the present invention, the group of candidate nodes may be determined based on states of the plurality of nodes. Usually, the distributed system may comprise multiple replicas of the application data 414 so as to increase the reliability. Accordingly, the data distribution of the application data 414 among the plurality of nodes maybe considered in determining the group of candidate nodes. Table 1 shows an example data distribution of replicas of the application data 414.

TABLE 1
Data Distribution of Replicas of Application Data

| ID | Application | Application Data | Location of Replica |
|---|---|---|---|
| 1 | Application 412 | Application Data 414 | Node 410, Node 420 |
| . . . | . . . | . . . | . . . |

In Table 1, there are four columns, where the first column represents an identification of entries in the table, the second column represents a name of the application, the third column represents the application, and the fourth column represents locations of replicas of the application data. The number of the replicas depend on the replica rule of the distribute system. Although two replicas are shown in the above table, more replicas may exist according to another replica rule. Hereinafter, reference will be made to FIG. 7 for further descriptions.

FIG. 7 depicts an example diagram 700 for a distributed system comprising multiple replicas of the application data according to an embodiment of the present invention. In FIG. 7, the distributed system comprises two replicas for the application data 414, where one is the application data 414 itself located in the node 410, and the other is application 710 located in the node 420. In some embodiments of the present invention, the group of candidate nodes may be adjusted based on the data distribution of the replicas. Accordingly, the node 420 which already has the replica of the application data 414 may be preferentially determined as a candidate node. Based on the data distribution of Table, the node 420 may be considered as a candidate node.

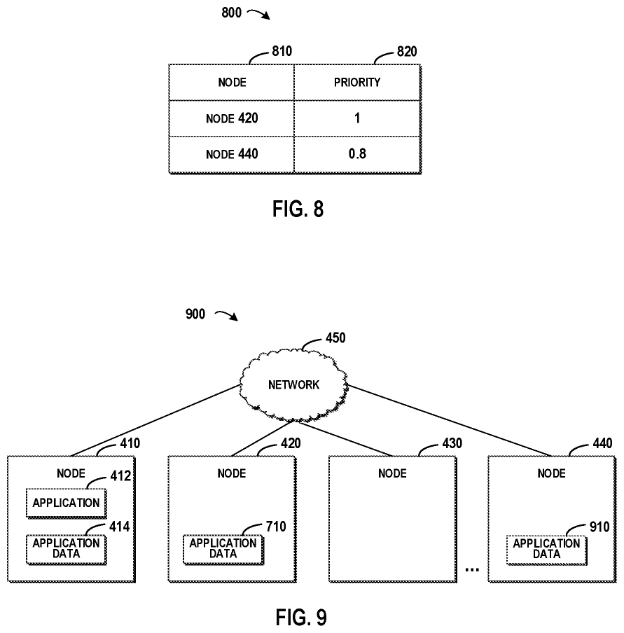

In some embodiments of the present invention, each candidate node may be assigned with a flag indicating whether a replica of the application data is located at the candidate. Reference will be made to FIG. 8 for more details, which figure depicts an example diagram 800 for a group of candidate nodes according to an embodiment of the present invention. In FIG. 8, two columns may be comprised in the group of candidate nodes, where the first column 810 represents the name of the node, and the second column 820 represents the priority of the node. If it is determined that one candidate node already has the replica of the application data 414 based on the flag, it may indicate that the relocating step may be omitted, and thus the candidate node may be given a higher priority. In the above example, as the node 420 already has the application data 710, the node 420 may be given a higher priority with the value of “1” (or another value).

If one candidate node does not have the replica of the application data, it may indicate that the relocating step should be performed, and thus the candidate node may be given a priority that is lower than that of the candidate node having the replica. As the node 440 does not have any replica, the node 440 may be given a lower priority with the value of “0.8” (or another value). With these embodiments, the application data may be relocated to the group of candidate nodes in advance to ensure that the migrated application may be run immediately at any of the candidate node. Here, the candidate nodes may be sorted according to the priority and thus the node 420 which already has the application data 710 may be preferentially determined as a candidate node. Therefore, the total relocation cost may be reduced and the migration may be implemented in a more effective way.

Referring back to FIG. 5, at block 540, the application data 414 of the application 412 may be relocated from the node 410 to the group of candidate nodes. In some embodiments, the application data 414 may be copied from the node 410 to the group of candidate nodes. With these embodiments, the application data 414 may be copied to multiple candidate nodes that have a high probability to be a destination node for the migration, such that the application data 414 may be migrated to a potential destination node in advance. Therefore, both of the application 412 and its corresponding application data 414 may be migrated to the destination node in a fast way.

In some embodiments of the present invention, the method 500 may be implemented at a migration manager for controlling the migration of the application 412 and the corresponding application data 414. At this point, the migration manager may schedule all the steps in the migration and directly adds steps in the method 500 before real migrating the application 412. Accordingly, the application data 414 may be relocated to the group of candidate nodes in advance before the application 412 itself is migrated.

In some embodiments of the present invention, the method 300 may be implemented at another manager other than the migration manager. At this point, in order to make sure that the node 410 will not start the migration of the application 412 before the relocation of the application data 414, the node 410 may be notified to delay a migration of the application 412 from the node 410 to a candidate node of the candidate nodes, so as to prevent a situation where the application itself is migrated to a candidate node before the application data is relocated to the candidate node.

In some embodiments of the present invention, if the application data 414 has already been relocated to the candidate node, the node 410 may be notified to start the delayed migration of the application 412. With these embodiments, once the relocation of the application data 414 is completed, the application 412 may be immediately migrated to the candidate node. Therefore, the migrated application may be directly run based on the application data that is prepared in the candidate node in advance.

In some embodiments of the present invention, the application data 414 may be copied to the group of candidate nodes during the relocation. In some embodiments of the present invention, the application data 414 may be moved to the group of candidate nodes during the relocation. No matter which operation of copying and moving is adopted, the data distribution of the application data 414 may change. At this point, more replicas of the application data 414 may exist in the plurality of nodes, and thus the data distribution of replicas may be updated based on locations of relocated application data, so as to reflect the latest distribution of the replicas.

FIG. 9 depicts an example diagram 900 for a distributed system where data distribution of replicas for application data 414 is changed according to an embodiment of the present invention. Continuing the above example, there are two candidate nodes 420 and 440, and the data distribution of replicas changes after the application data 414 is copied to the node 440 to form the application data 910. At this point, the data distribution of Table 1 may be updated to Table 2 as below for reflecting the latest data distribution.

TABLE 2
Updated Data Distribution of Replicas of Application Data

| ID | Application | Application Data | Location of Replica |
|---|---|---|---|
| 1 | Application 412 | Application Data 414 | Node 410, Node 420, |
| | | | Node 440 |
| . . . | . . . | . . . | . . . |

In some embodiments of the present invention, after the application data 414 has been relocated, the application 412 may be migrated to a candidate node in the group of candidate nodes to which the application data has been relocated. In these embodiments, the application 412 may be migrated to a candidate node selected from the group. With these embodiments, as the application data 414 has already been relocated to the selected candidate node, the migrated application may be immediately launched and run based on the application data, such that the downtime of the application may be greatly reduced compared with the solution for copying the application data after the application migration is completed.

In some embodiments of the present invention, the candidate node may be selected by the scheduler for migration. As the group of candidate nodes already cover most of the potential destination for migration, a node in the group of candidate nodes is very likely to be selected by the scheduler.

It is to be understood that the replicas in the candidate nodes are for the purpose of application migration. Once the application migration is finished, the redundant replica may be removed. In some embodiments of the present invention, if a predetermined time duration has elapsed after the migration of the application 412, a redundant replica of the application data 414 is not useful any more. Therefore the redundant replica(s) may be removed from the plurality of nodes. A rule may be determined for removing the redundant replicas. According to one rule, the replica in a candidate node other than the destination node to which the application is migrated may be removed. According to another rule, an original replica in a node may be removed.

Further, a replica rule may define how many replicas should be maintained in the distributed system. If the replica rule indicates that two replicas should be retained, then only two replicas may be retained in the plurality of nodes. Continuing the above example in FIG. 9, there are three replicas before the application migration, if the application 412 is migrated to the node 440, then any of the application data 414 and 710 should be removed to ensure that the total number of replicas equals to 2. In another example, if three original replicas are located in the plurality of nodes and three nodes having no replica are selected as candidate nodes, then there may be six replicas after the migration and three of them should be removed to ensure that the total number of replicas equals to 3.

In some embodiments of the present invention, the application 412 may be a container in a container orchestration engine, the application data 414 may be a persistent volume for the container, and the plurality of nodes may be worker nodes in the container orchestration engine. Although the invention describes the details for the application migration by taking a container as an example application, the embodiments of the present invention may be applied to another type of application, as along as the application has its own application data for supporting the application.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
detecting, by one or more processors, an application is to be migrated in response to detecting an event in a node in a plurality of nodes, the application and application data of the application being located in the node;
determining, by one or more processors, a group of candidate nodes to which the application is to be migrated from the plurality of nodes; and
relocating, by one or more processors, the application data of the application from the node to the group of candidate nodes.

2. The method of claim 1, further comprising:
migrating, by one or more processors, the application to a candidate node in the group of candidate nodes to which the application data has been relocated.

3. The method of claim 1, wherein the event in the node comprises any of:
a performance of the node being below a predefined threshold;
a failure being detected in the node; and
an instruction for migrating the application.

4. The method of claim 1, wherein the determining the group of candidate nodes comprises:
determining, by one or more processors, the group of candidate nodes based on states of the plurality of nodes.

5. The method of claim 4, wherein the determining the group of candidate nodes based on states of the plurality of nodes further comprises:
determining, by one or more processors, a data distribution of replicas of the application data among the plurality of nodes; and
adjusting, by one or more processors, the group of candidate nodes based on the data distribution of the replicas.

6. The method of claim 5, wherein the adjusting the group of candidate nodes comprises:
assigning, by one or more processors, a higher priority to a node in which a replica of the application data locates in determining the group of candidate nodes.

7. The method of claim 1, further comprising:
notifying, by one or more processors, the node to delay a migration of the application from the node to a candidate node of the candidate nodes in response to the application data not having been relocated.

8. The method of claim 7, further comprising:
notifying, by one or more processors, the node to start the delayed migration of the application in response to the application data having been relocated.

9. The method of claim 1, further comprising:
updating, by one or more processors, a data distribution of replicas of the application data based on the relocated application data.

10. The method of claim 2, further comprising:
removing, by one or more processors, redundant application data from the plurality of nodes based on a replica rule of the plurality of nodes in response to a predetermined time duration being passed after the application being migrated.

11. A computer-implemented system, comprising a computer processor coupled to a computer-readable memory unit, the memory unit comprising instructions that when executed by the computer processor implements a method comprising:
detecting an application is to be migrated in response to detecting an event in a node in a plurality of nodes, the application and application data of the application being located in the node;
determining a group of candidate nodes to which the application is to be migrated from the plurality of nodes; and
relocating the application data of the application from the node to the group of candidate nodes.

12. The system of claim 11, wherein the method further comprises:
migrating the application to a candidate node in the group of candidate nodes to which the application data has been relocated.

13. The system of claim 11, wherein the event in the node comprises any of:
a performance of the node being below a predefined threshold;
a failure being detected in the node; and
an instruction for migrating the application.

14. The system of claim 11, wherein the determining the group of candidate nodes comprises:
determining the group of candidate nodes based on states of the plurality of nodes.

15. The system of claim 14, wherein the determining the group of candidate nodes based on states of the plurality of nodes further comprises:
determining a data distribution of replicas of the application data among the plurality of nodes; and
adjusting the group of candidate nodes based on the data distribution of the replicas.

16. The system of claim 15, wherein the adjusting the group of candidate nodes comprises:
assigning a higher priority to a node in which a replica of the application data locates in determining the group of candidate nodes.

17. The system of claim 11, wherein the method further comprises:
notifying the node to delay a migration of the application from the node to a candidate node of the candidate nodes in response to the application data not having been relocated.

18. The system of claim 17, wherein the method further comprises:
notifying the node to start the delayed migration of the application in response to the application data having been relocated.

19. The system of claim 11, wherein the method further comprises:
updating a data distribution of replicas of the application data based on the relocated application data.

20. A computer program product, the computer program product comprising a computer readable storage medium having program instructions embodied therewith, the program instructions executable by an electronic device to cause the electronic device to perform actions of:
detecting an application is to be migrated in response to detecting an event in a node in a plurality of nodes, the application and application data of the application being located in the node;
determining a group of candidate nodes to which the application is to be migrated from the plurality of nodes; and
relocating the application data of the application from the node to the group of candidate nodes.
